(19) United States
(12) Patent Application Publication
(10) Pub. No.: US 2016/0090236 A1
(43) Pub. Date: Mar. 31, 2016

(54) ORE SUPPLY APPARATUS AND ORE SUPPLY METHOD

(71) Applicant: SUMITOMO METAL MINING CO., LTD., Tokyo (JP)

(72) Inventors: Hideki Kikutani, Tokyo (JP); Hisayuki Okada, Tokyo (JP); Daishi Ochi, Tokyo (JP); Takeshi Nakamura, Tokyo (JP); Kenji Sato, Tokyo (JP)

(21) Appl. No.: 14/500,483

(22) Filed: Sep. 29, 2014

(51) Int. Cl. B65D 88/54; B65G 65/40

(52) U.S. Cl. CPC B65D 88/54; B65G 65/40

(57) ABSTRACT

The present invention provides an ore supply apparatus and an ore supply method which are capable of securing a stable ore-supply amount. The ore supply apparatus 20 according to the present invention includes a storage unit 21 configured to store an ore slurry, a piping unit 22 configured to discharge the ore slurry from the storage unit 21, a control valve provided to the piping unit 22 and configured to change the cross-sectional area of a flow path of the piping unit 22, and a buffer container 60 provided with an outlet 64 and configured to once accommodate the ore slurry discharged from the piping unit 22 and then supply said ore slurry into a concentrator from the outlet 64 at a predetermined flow rate.

### BACKGROUND OF THE INVENTION

1. Field of the Invention

The present invention relates to an ore supply apparatus for concentrators used for recovering a concentrate from an ore, and relates to an ore supply method.

2. Description of the Related Art

Various mineral processing methods have been used for recovering a concentrate from an ore. For example, as a mineral processing method for gold ores, there have been employed a method in which a gold ore is crushed and then pulverized into fine particles having an appropriate particle size, and, using a cyanide process of suspending the recovered concentrate particles in a cyanide aqueous solution thereby to leach gold, gold is separated and condensed from a gangue mineral and a sulfide mineral; and a method in which a gold concentrate is separated and condensed from a gangue mineral and a sulfide mineral by gravity concentration and floatation, and furthermore, gold is separated and condensed from the recovered gold concentrate by the cyanide process.

The cyanide process employed in the above-mentioned methods has a problem that, some of gold contained in coarse ore particles cannot be dissolved, and accordingly, gold is insufficiently recovered.

Therefore, as a method for recovering a gold concentrate of high grade which is capable of being directly refined only by gravity concentration, there has been proposed a table gravity concentration (also called flowing-film concentration) (for example, Patent Literature 1). Furthermore, Patent Literature 2 discloses a technique of automating the adjustment of a partition plate with a combination of the above-mentioned table gravity concentration and image processing.

FIG. 24 illustrates a principle of table gravity concentration. In table gravity concentration, an ore slurry 105 is supplied from an ore supply launder 101 to a shaking table 100 provided with a plurality of riffles 104, the ore slurry 105 being produced by pulverizing an ore into ore particles and adding water thereto, meanwhile, water 106 is supplied from a water supply launder 102 while the shaking table 100 is shaken. Using the difference in “the way of flow” of the ore slurry on the shaking table 100 caused by the specific gravity and the particle diameter of solids (ore particles) contained in the ore slurry, a flow 107 of ore particles of high gold grade is formed, and only this flow is collected using a partition plate 103, thereby being separated. A portion of the flow of ore particles of high gold grade is called “gold line”.

A gold concentrate recovered by such method is directly smelted and cast, and produced as an ingot product having a purity of not less than 90% (sometimes called a dore).

PTL 1: U.S. Pat. No. 6,818,042

PTL 2: Japanese Patent Application Laid-Open No. 2012-139675

PTL 3: Japanese Unexamined Utility Model Registration Application Publication No. H06-051655

Generally, to stably recover a concentrate using a table concentrator, it is important to supply an ore (an ore slurry and additive water) at a uniform velocity. For example, as described in Patent Literature 3, a change in the method of controlling a valve is indispensable for achieving stable ore-supply (stabilization of ore supply amount and ore supply velocity).

As a control valve configured to control a flow rate of an ore slurry supplied to a table from an ore supply tank, there has been used a valve which is configured to control a cross-sectional area of a flow path by pneumatically driving a valve body made of elastomer. Such valve makes a too large clearance at the time when the opening degree of the valve is adjusted to a minimum, and accordingly, even an ore slurry having a low fluidity flows out at once, and therefore, a supply amount of the ore slurry is not able to be appropriately adjusted.

On the other hand, in the case of another kind of valve capable of achieving a smaller opening degree (butterfly valve or the like), when the opening degree of the valve is fixed, an ore slurry is immediately clogged up, thereby causing a blockage in piping. This is because the specific gravity of solids contained in an ore slurry is high, and therefore the sedimentation velocity of the solids is high and the ore slurry is easily filled in a lower portion of an ore supply tank. As a result, a stable ore supply amount cannot be secured, which is an obstacle to table mineral processing operation.

Here, the above-mentioned “to secure an ore supply amount” represents that, even if there is a change in the flow velocity of an ore slurry, the ore slurry can be continuously supplied in without causing a blockage in piping, and, on the average of ore supply within a certain time, a desired ore supply can be realized.

The present invention aims to provide an ore supply apparatus and an ore supply method which are capable of securing a stable ore supply amount.

### SUMMARY OF THE INVENTION

To solve the above-mentioned problem, an ore supply apparatus according to the present invention comprises: a storage unit configured to store an ore slurry; a piping unit configured to discharge the ore slurry from the storage unit; a control valve provided to the piping unit and configured to change a cross-sectional area of a flow path of the piping unit; and a buffer container provided with an outlet and configured to once accommodate the ore slurry discharged from the piping unit and then supply the ore slurry into a concentrator from the outlet at a predetermined flow rate.

To solve the above-mentioned problem, the present invention provides an ore supply method, the method comprising: supplying an ore slurry into a concentrator via a piping unit from a storage unit configured to store the ore slurry, wherein the piping unit is provided with a control valve configured to change a cross-sectional area of a flow path of the piping unit, and the ore slurry discharged from the piping unit is accommodated in a buffer container once and supplied into a concentrator from an outlet provided to said buffer container.

According to the present invention, there is provided a structure configured to change a cross-sectional area of a flow path of an ore slurry by a control valve. Furthermore, according to the present invention, a buffer container is configured to once accommodate an ore slurry discharged from a piping unit, and then make the ore slurry flow out of an outlet of the buffer container, thereby supplying the ore slurry into a concentrator, and therefore, even if the flow rate of the ore slurry supplied from the piping unit varies, the variation is absorbed, whereby a stable ore supply can be achieved.

### BRIEF DESCRIPTION OF THE DRAWINGS

FIG. 1 is a schematic side view illustrating the whole structure of a table gravity concentrator.

FIG. 2 is a schematic plan view illustrating the whole structure of the table gravity concentrator.

FIG. 3 illustrates a structure of an ore supply tank.

FIG. 4 is a plan view of the ore supply tank.

FIG. 5 illustrates a way of installing a sealing pipe (sealing device).

FIG. 6 illustrates another way of installing a sealing pipe (sealing device).

FIG. 7 illustrates a way of installing a sealing top (sealing device).

FIG. 8 illustrates a way of installing a sealing pipe (sealing device).

FIG. 9 is a cross-sectional perspective view of a control valve.

FIG. 10 is a longitudinal section view illustrating a state of the control valve at the time when the opening degree of the control valve is adjusted to a maximum.

FIG. 11 is a cross-sectional view along line A-A of FIG. 10.

FIG. 12 is a longitudinal section view illustrating a state of the control valve at the time when the opening degree of the control valve is adjusted to a minimum.

FIG. 13 is a cross-sectional view along line B-B of FIG. 12.

FIG. 14 is a cross-sectional view along line B-B of FIG. 12 (in the case of no sealing pipe).

FIG. 15 shows an example of controlling the control valve.

FIG. 16 is a side view illustrating a structure of a buffer container.

FIG. 17 is a plan view illustrating the structure of the buffer container.

FIG. 18 is a front side view of the buffer container.

FIG. 19 is a back side view of the buffer container.

FIG. 20 is a left side view of the buffer container.

FIG. 21 is a right side view of the buffer container.

FIG. 22 is a plan view of the buffer container.

FIG. 23 is a bottom view of the buffer container.

FIG. 24 illustrates a principle of table concentration.

### DETAILED DESCRIPTION OF THE PREFERRED EMBODIMENTS

Hereinafter, embodiments according to the present invention will be explained in detail with reference to the drawings. In the following embodiments, there will be explained an example in which an ore slurry produced by adding water to pulverized gold ore particles is supplied into a table gravity concentrator, but, the present invention may be applied to other kinds of ore slurry and other types of concentrators.

FIG. 1 is a schematic side view illustrating the whole structure of a table gravity concentrator 1 of a first embodiment according to the present invention. The table gravity concentrator 1 comprises a shaking table 2, a dam 3, an ore supply launder 4, a water supply launder 5, a concentrate storage tank 9, and a tailing storage tank 10. The shaking table 2 is arranged so as to be inclined to be higher at the right end thereof in FIG. 1 than at the left end thereof, and supported by a frame not illustrated. The dam 3, the ore supply launder 4, and the water supply launder 5 are provided on the top surface of the shaking table 2, and, as is the case with the shaking table 2, are arranged so as to be inclined in a right-and-left direction of FIG. 1 to be higher at the right end thereof than at the left end thereof. The concentrate storage tank 9 is a container to store a concentrate, for example, gold. The tailing storage tank 10 is a container to store tailings. The concentrate storage tank 9 and the tailing storage tank 10 are arranged in such a way that the top surfaces thereof are positioned lower than the top surface of the shaking table 2 in a vertical direction. A shaking driving mechanism 7 configured to shake the shaking table 2 in a right-and-left direction of FIG. 1 is provided at the right end of the shaking table 2. An ore supply tank 20 (an example of an ore supply apparatus) to supply an ore slurry into the table gravity concentrator 1 is provided above the ore supply launder 4. At the left end of the shaking table 2, there is provided a partition plate 8 to separate a concentrate and tailings and make the concentrate storage tank 9 and the tailing storage tank 10 accommodate the concentrate and the tailings, respectively.

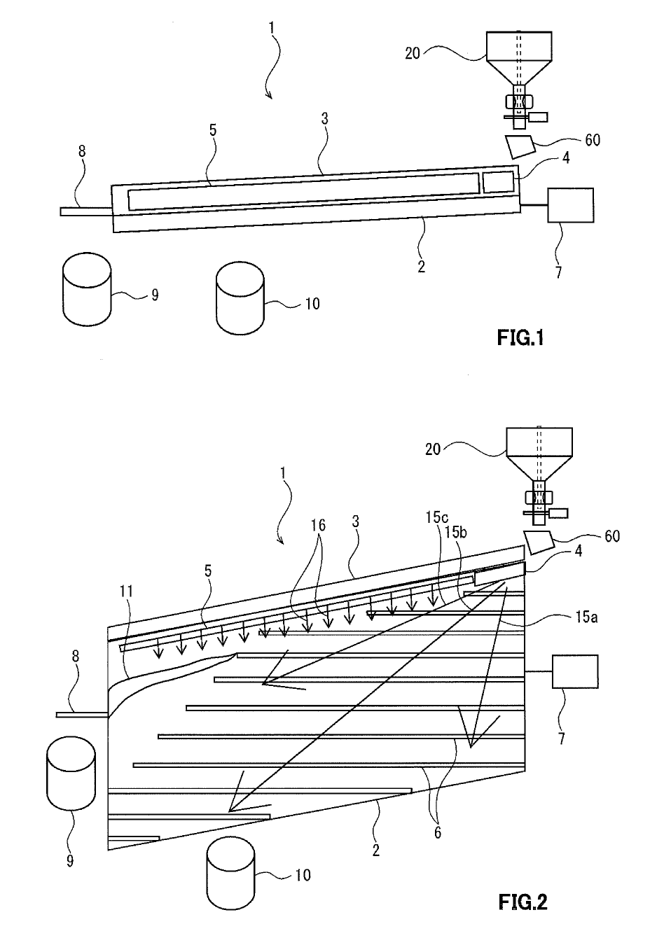

FIG. 2 is a schematic plan view illustrating the whole structure of the table gravity concentrator 1. The shaking table 2 is a tabular member whose plan shape is a parallelogram. The shaking table 2 is inclined in a right-and-left direction as illustrated in FIG. 1, and also arranged so as to be inclined in an upper and lower direction of FIG. 2 to be higher at the upper side thereof in FIG. 2 than at the lower side thereof. In other words, the shaking table 2 is arranged to be inclined so that the top-right corner portion thereof in FIG. 2 is positioned highest, meanwhile the bottom-left corner portion thereof is positioned lowest.

On the top surface of the shaking table 2 except the upper-left portion thereof in FIG. 2, a plurality of riffles 6 each being a tabular member and extending in a right-and-left direction is arranged so as to project upward. Furthermore, in the upside of the shaking table 2, the wall-like dam 3 is formed over the overall length of the shaking table 2 so as to prevent an ore slurry and water from flowing out of the upside of the shaking table 2. In the right end portion in the lower side of the dam 3, there is provided the ore supply launder 4 configured to supply an ore slurry supplied from the ore supply tank 20 via a buffer container 60 (The ore supply tank 20 and the buffer container 60 serve as an example of an ore supply apparatus.) into the shaking table 2. In the remaining portion in the lower side of the dam 3, there is provided the water supply launder 5 over the almost overall length of the dam 3 in a longitudinal direction, the water supply launder 5 being configured to supply water into the shaking table 2 as an arrow 16 of FIG. 2 indicates.

The ore supply launder 4 is, for example, a launder-like metal member having a U-shaped cross section, and is configured to supply an ore slurry supplied from the ore supply tank 20 via the buffer container 60 into the shaking table 2, for example, by making the ore slurry flow out of an opening portion provided on the undersurface of the ore supply launder 4.

The water supply launder 5 is, for example, a launder-like metal member having a L-shaped cross section of which the upper side and the dam 3 side are open, and is configured to supply water supplied from water supply hose, not illustrated, into the shaking table 2 by making the water flow out to the side of the dam 3. The water once flows out of the water supply launder 5 toward the upper side of FIG. 2, and then rebounds from the dam 3 and flows downward.

An ore slurry flows approximately in a direction from upper right to lower left in FIG. 2 according to the inclination of the top surface of the shaking table 2. Among ore particles contained in the ore slurry, ore particles having a smaller particle diameter or a lower specific gravity easily get over the riffles 6 and thus flow as an arrow 15a of FIG. 2 indicates. Ore particles having a larger particle diameter or a higher specific gravity resist getting over the riffles 6, and thus flow along the riffles 6 and flow as arrows 15b and 15c of FIG. 2 indicate. In this example, gold particles contained in an ore slurry form a gold line 11 from an end of the fourth riffle 6 from the top, and flow, and are separated from tailings at the left end of the shaking table 2 by the partition plate 8, and then accommodated in the concentrate storage tank 9. The remaining part of the ore slurry other than the gold particles is accommodated in the tailing storage tank 10 at the downstream end of the shaking table 2.

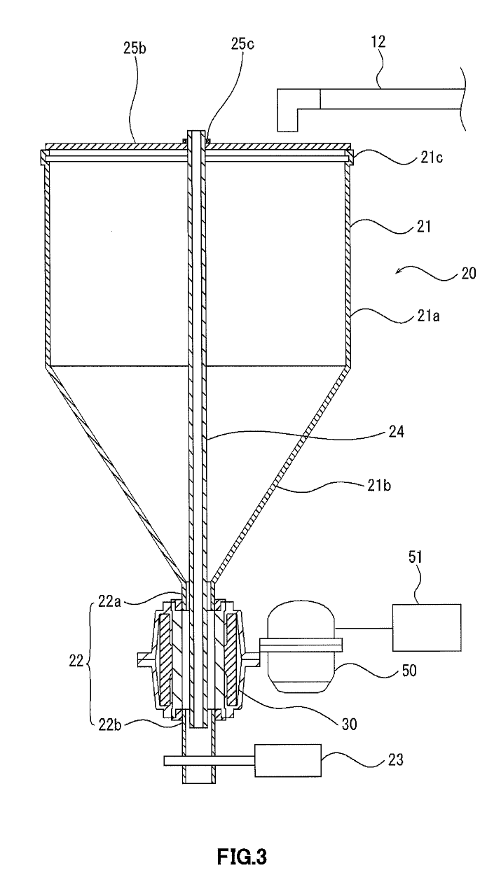

FIG. 3 illustrates a structure of the ore supply tank 20, and shows longitudinal section views of the ore supply tank 20, a sealing pipe 24, a supporting member 25b, and a control valve 30. The ore supply tank 20 is an apparatus configured to store an ore slurry once and then supply the ore slurry via the buffer container 60 into the ore supply launder 4, the ore slurry being supplied from piping 12 communicating with an ore slurry manufacturing facility not illustrated. The ore supply tank 20 comprises: a storage unit 21 configured to store an ore slurry; and a piping unit 22 configured to transfer the ore slurry from the storage unit 21 to the ore supply launder 4. The storage unit 21 comprises: an upper portion 21a which has a tube shape and of which the upper end is open; and a lower portion 21b which has a funnel shape and almost the same height as that of the upper portion 21a. The lower end of the upper portion 21a and the upper end of the lower portion 21b are connected by welding or the like. Furthermore, a flange 21c is provided in the circumference of the upper end of the upper portion 21a for reinforcement.

The piping unit 22 comprises: a pipe 22a whose upper end is connected to the lower end of the lower portion 21b of the storage unit 21, meanwhile whose lower end is connected to an inlet port of the control valve 30; and a pipe 22b whose upper end is connected to an outlet port of the control valve 30. The pipe 22a and the pipe 22b each are, for example, a steel pipe, and have a diameter which is determined in such a way as to achieve an appropriate flow rate of an ore slurry flowing out, with consideration of the throughput of the table gravity concentrator 1 per unit time.

The control valve 30 configured to control the flow rate of an ore slurry is provided in the middle of the piping unit 22, meanwhile a gate valve 23 is provided in the vicinity of the lower end of the piping unit 22. The gate valve 23 is capable of being fully opened or fully closed, but, incapable of being half-opened or half-closed. In this embodiment, as mentioned later, a flow of an ore slurry can be completely interrupted by the control valve 30 and the sealing pipe 24, and therefore, the gate valve 23 is not necessarily required, but is preferably provided for safety.

The control valve 30 is provided with an actuator 50 configured to pneumatically drive the control valve 30 and a control unit 51 configured to control the actuator 50. The control unit 51 is a computer which is electrically connected to the actuator 50, and is configured to adjust the opening degree of the control valve 30 via the actuator 50.

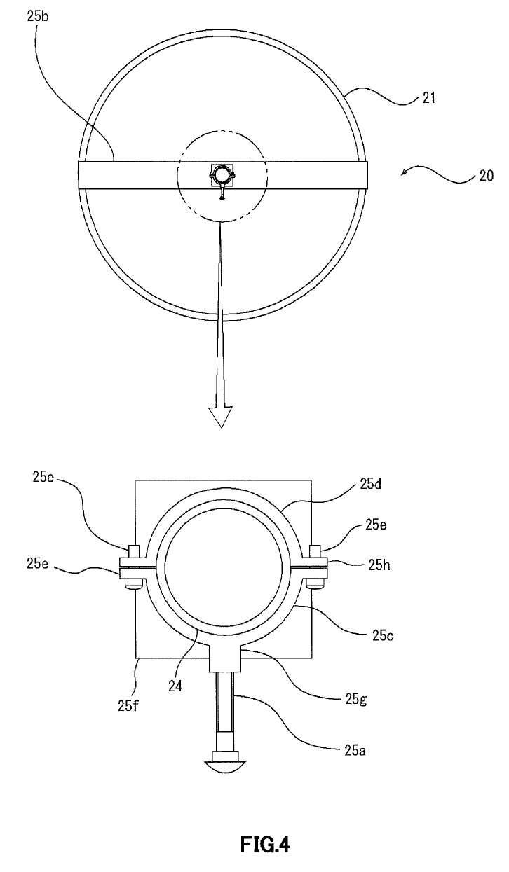

The sealing pipe 24 (an example of a sealing device) is provided in the central portion of a flat surface of the ore supply tank 20 (also refer to FIG. 4). The outer diameter of the sealing pipe 24 is slightly larger than a diameter of an ore slurry flow path having a circular section and being left at the time when the opening degree of the control valve 30 is adjusted to a minimum. The upper end of the sealing pipe 24 protrudes upward from the upper end of the storage unit 21, meanwhile the lower end of the sealing pipe 24 protrudes downward from the outlet-side end portion of the control valve 30. A bolt 25a and ring plates 25c and 25d are provided in the vicinity of the upper end portion of the sealing pipe 24, and the sealing pipe 24 is supported by the supporting member 25b via the bolt 25a and the ring plates 25c and 25d. A configuration and a supporting method of the sealing pipe 24 will be mentioned later.

FIG. 4 is a plan view of the ore supply tank 20. The supporting member 25b around the center of which an opening portion 25f is provided is laid over the storage unit 21 in a diameter direction of the storage unit 21. In the sealing pipe 24, the ring plates 25c and 25d are fixed by two sets of nuts and bolts 25e. The ring plate 25c is provided with a threaded portion 25g, and the bolt 25a is screwed into the threaded portion 25g. The sealing pipe 24 is supported by the supporting member 25b in such a way that each flat portion 25h of the ring plates 25c and 25d and the bolt 25a are caught on the circumference of the opening portion 25f.

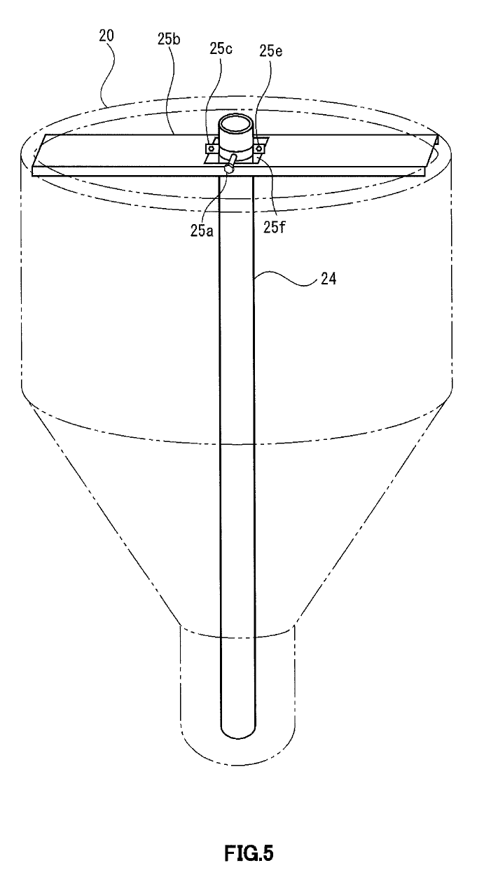

FIG. 5 illustrates a way of installing the sealing pipe 24 into the ore supply tank 20. The supporting member 25b is a flat steel member having a groove-shaped cross-section, wherein the height of a web is smaller than the width of the flange. With the opening side of the supporting member 25b being down, the supporting member 25b is fixed at the upper edge of the storage unit 21 of the ore supply tank 20 so as to be laid over the storage unit 21 in a diameter direction of the storage unit 21. The rectangular opening portion 25f is provided in the center portion of the supporting member 25b so that the sealing pipe 24 can penetrate the supporting member 25b. Since the supporting member 25b is arranged in a diameter direction of the storage unit 21, the opening portion 25f is positioned at the planar center of the storage unit 21.

The ring plates 25c and 25d are tabular metal members which are semicircularly bent with a bend radius slightly more than the outer diameter of the sealing pipe 24, and both ends of each of the ring plates 25c and 25d are provided with flat portions 25h for bolting. The ring plate 25c is provided with the threaded portion 25g, and the bolt 25a is screwed into said threaded portion 25g. The ring plates 25c and 25d are fixed with two sets of nuts and bolts 25e so as to sandwich a portion in the vicinity of the upper end of the sealing pipe 24, for example, a portion positioned approximately 2 inches (51 mm) from the upper end of the sealing pipe 24 (also refer to FIG. 4).

The sealing pipe 24 having the ring plates 25c and 25d attached thereto is dropped into the inside of the ore supply tank 20 through the opening portion 25f, starting with the lower end of the sealing pipe 24. Then, the lower end portion of the bolt 25a and the lower end portion of the flat portion 25h come into contact with the upper surface of the flange portion in the circumference of the opening portion 25f of the supporting member 25b, whereby a position of the sealing pipe 24 in a vertical direction is settled. Here, the bolt 25a and the flat portion 25h only come into contact with the supporting member 25b, and are not fixed thereto by welding or the like. Therefore, at the time of maintenance work or the like, the sealing pipe 24 can be easily removed. Furthermore, the size of the opening portion 25f is large enough with respect to the outer diameter of the sealing pipe 24, and therefore, the sealing pipe 24 is movable in a horizontal direction (in the up-and-down, left-and-right direction of FIG. 4). Furthermore, the area of a contact portion between the bolt 25a and the supporting member 25b and the area of a contact portion between the flat portion 25h and the supporting member 25b each are small, and the sealing pipe 24 is supported at such contact portions and hence can rotate about the contact portions within a vertical plane.

In consideration of the properties of an ore slurry which is subject to be transferred, a material of the sealing pipe 24 may be suitably selected from metal, synthetic resin, and the like, but, a soft material having flexibility such as HDPE (high-density polyethylene) is preferably used. The reason for this is that, when a sleeve 34 (refer to FIG. 12) of the control valve 30 comes into contact with the outer surface of the sealing pipe 24, a change in the shape of the sealing pipe 24 allows the sealing pipe 24 to surely come into intimate contact with the sleeve 34.

It is only necessary that the sealing device is capable of sealing a flow path left at the time when the opening degree of the control valve 30 is adjusted to a minimum, and it is not necessary for the sealing device to have a length from the upper end of the ore supply tank 20 to the lower end of the control valve 30 as is the case with the sealing pipe 24 in FIG. 3. Furthermore, the sealing device does not need to have a tubular cross-section and may have a fully-filled cross-section

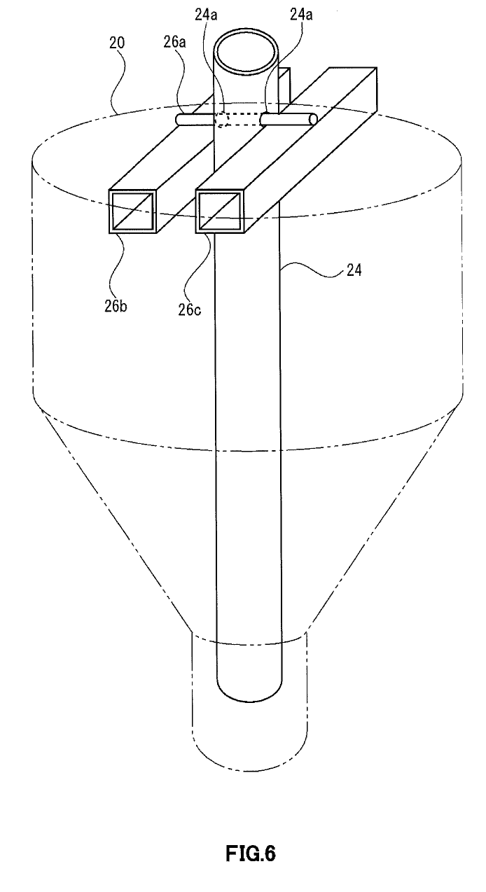

FIG. 6 illustrates another way of installing the sealing pipe 24 into the ore supply tank 20. In FIG. 6, for ease of legibility, the thickness of the sealing pipe 24, the bolt 26a, and the supporting members 26b and 26c relative to the ore supply tank 20 is shown emphasized.

The shape and the dimension of the sealing pipe 24 are the same as those shown in FIG. 5, and two holes 24a are provided in the vicinity of the upper end of the sealing pipe 24. Furthermore, one bolt 26a penetrates the sealing pipe 24 so as to protrude to both sides of the sealing pipe 24 from the holes 24a. As is the case with FIG. 5, the holes 24a are positioned, for example, approximately 2 inches (51 mm) from the upper end of the sealing pipe 24.

The supporting members 26b and 26c are rod-like members having a strength capable of supporting the sealing pipe 24. The supporting members 26b and 26c mentioned here have a cross-section having a square pipe shape of side approximately 1 inch (25 mm), but, the supporting members 26b and 26c may have a cross-section having another shape. The supporting members 26b and 26c are arranged in such a way as to be laid over the upper end of the storage unit 21 in parallel to the diameter direction of the storage unit 21, with sandwiching the planar center of the storage unit 21. The distance between the supporting members 26b and 26c is made slightly larger than the outer diameter of the sealing pipe 24.

The sealing pipe 24 is dropped into the inside of the ore supply tank 20 at a position in the vicinity of the planar center of the storage unit 21, between the supporting members 26b and 26c. Then, the lower end portion of the bolt 26a comes into contact with the upper surface of the supporting members 26b and 26c, whereby a position of the sealing pipe 24 in a vertical direction is settled. Here, the bolt 26a only comes into contact with the supporting members 26b and 26c, and is not fixed thereto by welding or the like. Therefore, at the time of maintenance work or the like, the sealing pipe 24 can be easily removed. Furthermore, the sealing pipe 24 is two-dimensionally movable in the axis direction of the bolt 26a (in a right-and-left direction of FIG. 4) and in the axis direction of the supporting members 26b and 26c (in the up-and-down direction of FIG. 4). Furthermore, the bolt 26a is in contact with the supporting member 26b and 26c at a linear portion thereof, and accordingly the sealing pipe 24 can rotate about the contact portions within a vertical plane.

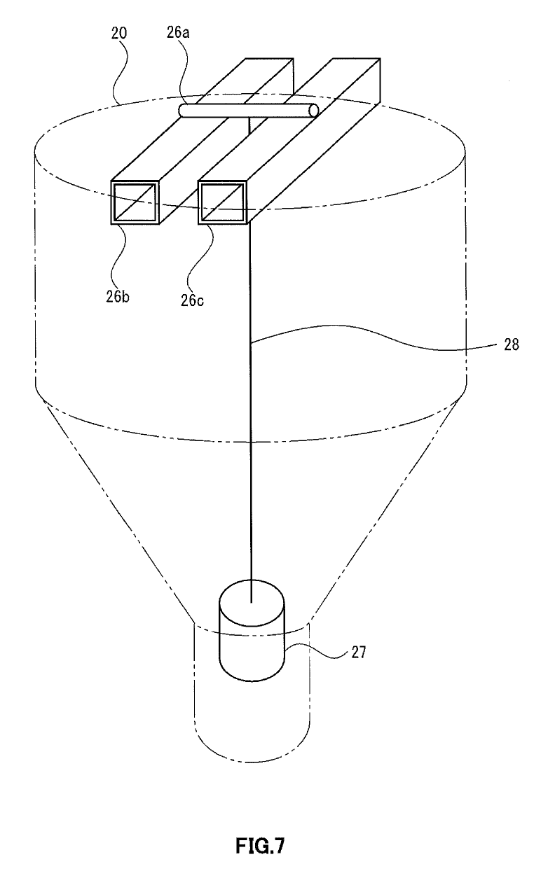

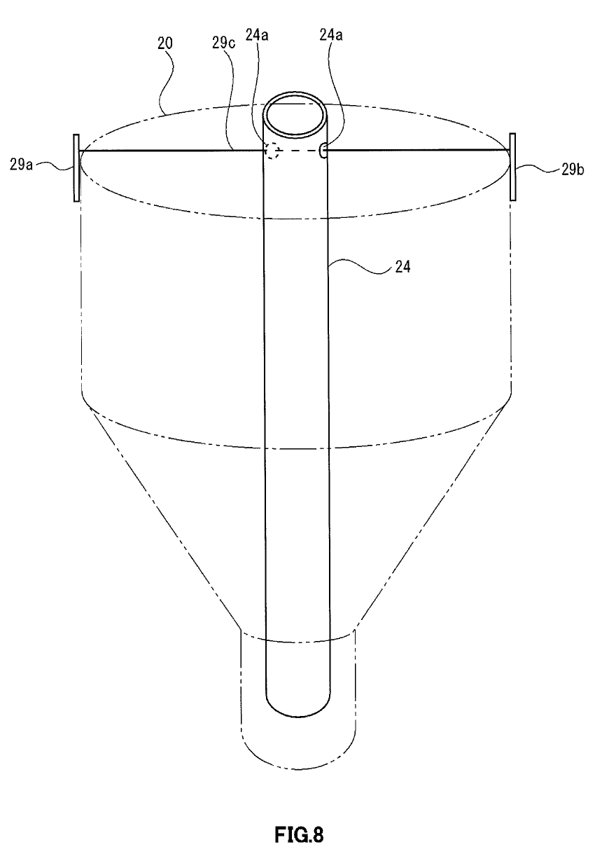

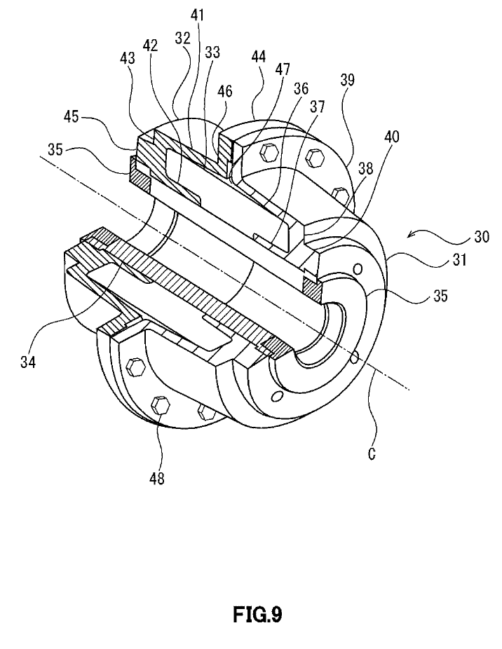

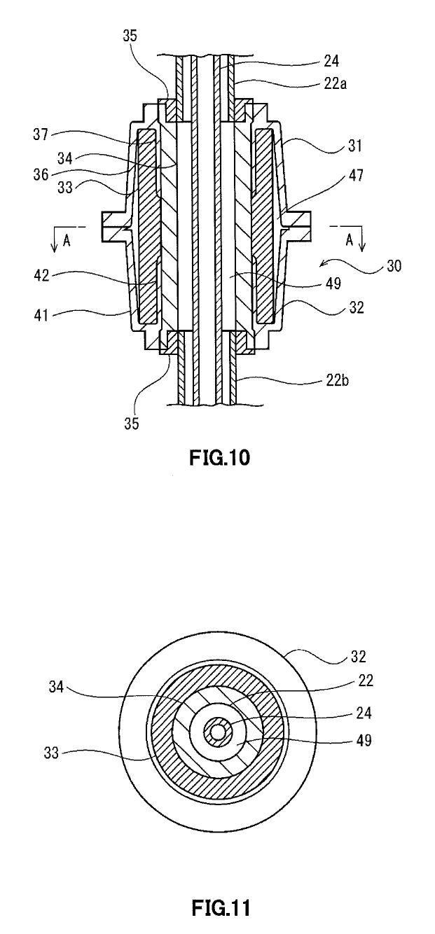

FIG. 7 illustrates another configuration example of a sealing device. In this example, a cylindrical sealing top 27 having a fully-filled cross-section is used as a sealing device. As is the case with the sealing pipe 24, the outer diameter of the sealing top 27 is slightly larger than the diameter (D2 in FIG. 14) of an ore slurry flow path left at the time when the opening degree of the control valve 30 is adjusted to a minimum. The length of the sealing device 27 in an up-and-down direction is made long enough to seal an ore slurry flow path left at the time when the opening degree of the control valve 30 is adjusted to a minimum. In this example, the length of the sealing device 27 in an up-and-down direction is made equivalent to the length of the sleeve 34 (refer to FIG. 10) of the control valve 30. As is the case with the sealing pipe 24, various materials may be used as a material of the sealing top 27, but, a material having flexibility is preferably used.

One end of a linear member 28 is connected to the upper end of the sealing top 27. The other end of the linear member 28 is connected to the vicinity of the center of the length of the bolt 26a. The linear member 28 is a long, narrow material having flexibility, such as a chain or a wire.

As is the case with the example in FIG. 6, the two supporting members 26b and 26c are arranged at the upper end of the storage unit 21; the bolt 26a is arranged in such a way as to be laid over the supporting members 26b and 26c in the vicinity of the center of the length of the supporting members 26b and 26c; and the sealing top 27 is hung and supported by the linear member 28. Also in this case, the bolt 26a is not fixed to the supporting members 26b and 26c by welding or the like. In the above-mentioned arrangement, the length of the linear member 28 is adjusted so that the sealing top 27 is positioned inside the control valve 30. Furthermore, since the bolt 26a is not fixed to the supporting members 26b and 26c, the sealing top 27 is two-dimensionally movable. Furthermore, since the linear member 28 is a member having flexibility, the sealing top 27 can rotate about a connecting point of the bolt 26a to the linear member 28 within a vertical plane.

FIG. 8 illustrates another configuration example of a sealing device. The sealing device is a sealing pipe 24 having the same shape and made of the same material as that of FIG. 5, and, has the same configuration as that of FIG. 6, wherein two holes 24a are provided in the vicinity of the upper end of the sealing pipe 24.

In this example, tabular fixing members 29a and 29b are fixed on the side faces of the ore supply tank 20 so as to be positioned symmetrically about the planar center of the storage unit 21. Then, one end of a linear member 29c penetrating the two holes 24a and the other end thereof are coupled to the fixing member 29a and the fixing member 29b, respectively. The linear member 29c is a long, narrow material having flexibility, such as a chain or a wire. The linear member 29c is preferably removably coupled to the fixing members 29a and 29b, for example, the linear member 29c has ring-shaped end portions, and said end portions are hung on hooks provided in the fixing members 29a and 29b, respectively, whereby the sealing pipe 24 can be easily removed. Also in the configuration in FIG. 8, the sealing pipe 24 is movable in the length direction of the linear member 29c, and can rotate about the linear member 29c.

FIG. 9 is a cross-sectional perspective view of the control valve 30. The control valve 30 comprises: housings 31 and 32 configured to constitute a valve box; a sleeve 34 configured to function as a valve body; a muscle 33 configured to transform the sleeve 34; and two retainers 35 configured to connect the piping unit 22.

The housing 31 is a member which is, for example, formed using casting by integrating: a tubular-shaped outer plate 36; a tubular-shaped inner plate 37 having an outer diameter smaller than that of the outer plate 36 and positioned inside the outer plate 36; a connecting member 38 configured to connect one end portion of the outer plate 36 to one end portion of the inner plate 37, each of said end portions being at a side where said outer plate 36 and said inner plate 37 are connected to the piping unit 22; a flange 39 provided in the other end portion of the outer plate 36, said end portion being at a side where the outer plate 36 is combined with the housing 32; and a protruding portion 40 provided in the connecting member 38. The length of the inner plate 37 in the direction of central axis C is slightly smaller than that of the outer plate 36. The outer diameter of the inner plate 37 is constant, meanwhile the outer diameter of the outer plate 36 slightly increases from one end to the other end thereof. Ductile cast iron, for example, is used as a material for the housing 31.

The form of the housing 32 is almost the same as that of the housing 31, and the housing 32 comprises an outer plate 41, an inner plate 42, a connecting member 43, a flange 44, and a protruding portion 45, however, the housing 32 differs from the housing 31 in that a notch 46 is provided in the flange 44. Ductile cast iron, for example, is used as a material for the housing 32.

The flange 39 of the housing 31 is coupled to the flange 44 of the housing 32 by a plurality of sets of nuts and bolts 48, and a space surrounded by the housing 31 and the housing 32 constitutes the valve box.

The muscle 33 is a tubular member, and is housed in a space formed by the outer plates 36 and 41 and the inner plates 37 and 42, with a slight space 47 being left in outer regions of the above-mentioned housing space. Elastomer, for example, synthetic rubber is used as a material for the muscle 33.

The sleeve 34 configured to function as a valve body of the control valve 30 has a tubular shape, and is arranged so that, when the control valve 30 is fully opened, the outer surface of the sleeve 34 comes into intimate contact with the inner surfaces of the inner plates 37 and 42. The inside diameter of the sleeve 34 is slightly larger than the inside diameter of the piping unit 22. Elastomer, for example, synthetic rubber is used as a material for the sleeve 34. A change in the shape of the sleeve 34 causes a change in the cross-sectional area of a flow path of an ore slurry, whereby the opening degree of the control valve 30 is adjusted. As an example of such valve, “C-Valve” manufactured by Pentair Valves & Controls has been known.

FIG. 10 is a longitudinal section view illustrating a state of the control valve 30 at the time when the opening degree of the control valve 30 is adjusted to a maximum. The two retainers 35 are connected to the pipes 22a and 22b of the piping unit 22, respectively. The muscle 33 is completely housed in a space formed by the outer plates 36 and 41 and the inner plates 37 and 42, and the inner surface of the muscle 33 coincides with the outer surfaces of the inner plates 37 and 42, meanwhile the inner surface of the muscle 33 is in contact with the outer surface of the sleeve 34. Without deformation of the sleeve 34 by the muscle 33, the outer surface of the sleeve 34 comes into contact with the inner surfaces of the inner plates 37 and 42, meanwhile the inner surface of the sleeve 34 extends straight. The sealing pipe 24 is arranged at a position in which the central axis of the sealing pipe 24 coincides with the central axes of the piping unit 22 and the sleeve 34. A space between the outer surface of the sealing pipe 24 and the inner surface of the sleeve 34 serves as a flow path 49 of an ore slurry. The distance between the outer surface of the sealing pipe 24 and the inner surface of the sleeve 34 is constant, hence, the cross-sectional area of the flow path 49 of an ore slurry is constant.

FIG. 11 is a cross-sectional view along line A-A of FIG. 10. The housing 32, the muscle 33, the sleeve 34, and the sealing pipe 24 are arranged so that each center thereof coincides with each other. An annular space between the sleeve 34 and the sealing pipe 24 serves as the flow path 49 of an ore slurry. It should be noted that, as mentioned above, the sealing pipe 24 is two-dimensionally removably arranged, and therefore, in this state, there is no problem even if the center position of the sealing pipe 24 deviates a little from the center position of the sleeve 34.

FIG. 12 is a longitudinal section view illustrating a state of the control valve 30 at the time when the opening degree of the control valve 30 is adjusted to a minimum. When a compressed air is sent into the space 47 by the actuator 50 (refer to FIG. 3), the muscle 33 is transformed in such a way as to protrude inward from a gap between the inner plate 37 and the inner plate 42, and presses the sleeve 34 inward. The sleeve 34 is transformed into an arc shape, and, at line B-B and in the vicinity of the upper and lower sides of line B-B, the inner surface of the sleeve 34 comes into intimate contact with the outer surface of the sealing pipe 24. Thus, the area of the flow path 49 of an ore slurry at end portions of the upper and lower sides of the sleeve 34 is equal to that in FIG. 11, but, the area of the flow path 49 gradually decreases toward the center of the sleeve 34, and then, at a portion in which the sleeve 34 comes into intimate contact with the sealing pipe 24, the area thereof is zero.

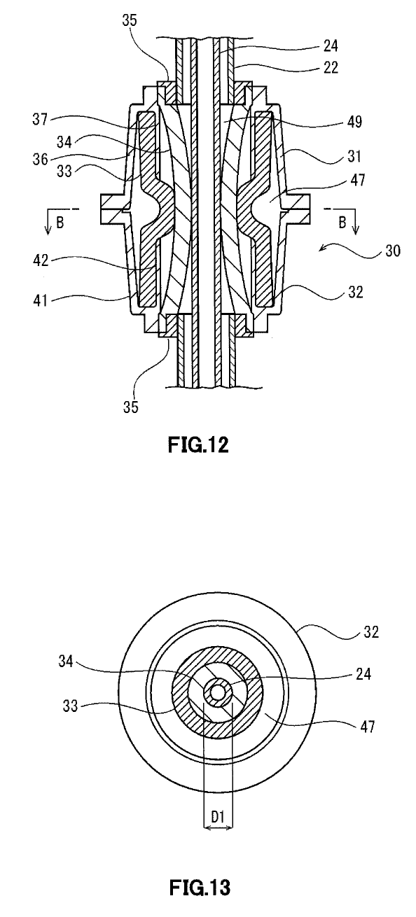

FIG. 13 is a cross-sectional view along line B-B of FIG. 12. The area of the space 47 is larger than that in FIG. 11 because of air pressure variation. Thus, the muscle 33 and the sleeve 34 are shrunk toward the center, and the inner surface of the sleeve 34 comes into intimate contact with the outer surface of the sealing pipe 24.

As is the case with FIG. 13, FIG. 14 is a cross-sectional view along line B-B of FIG. 12, but, illustrates a case in which there is neither sealing pipe 24 nor sealing top 27, in other words, a state of the control valve 30 at the time when the opening degree of the control valve 30 is kept to the original minimum. A diameter D2 of the inner surface of the sleeve 34 is slightly smaller than a diameter D1 (refer to FIG. 13) of the outer surface of the sealing pipe 24. For example, in the case where the D2 is 2 inches (51 mm), the use of a HDPE pipe having an inside diameter of 2 inches as the sealing pipe 24 preferably leads to an outside diameter D1 of approximately 2.4 inches (61 mm).

Besides the control valves having a valve body made of elastomer as shown in FIG. 9 to FIG. 14, another type of control valve such as a butterfly valve may be used as the control valve 30 as long as the control valve is capable of adjusting the cross-sectional area of a flow path of the piping unit 22. In the case where the control valve 30 is capable of adjusting the cross-sectional area of a flow path of the piping unit 22 to 0, a sealing device is unnecessary.

FIG. 15 shows an example of adjusting the opening degree of the control valve 30 by the control unit 51. The vertical axis shows the opening degree (%) of the valve, and the horizontal axis shows time (seconds). Here, the “opening degree” represents a ratio of a cross-sectional area of a flow path in a certain opening state of the control valve 30 with respect to a cross-sectional area of the flow path at the time when the control valve 30 is fully opened, at the center (line A-A in FIG. 10) of the control valve 30 provided with the sealing pipe 24.

(Step 0: Preparation)

An ore slurry is supplied into the ore supply tank 20 via the piping 12 (refer to FIG. 3) continuous from an upstream process. At this time, the opening degree of the control valve 30 is adjusted to a minimum so as to prevent the ore slurry from flowing through a flow path behind the control valve 30. The gate valve 23 is also closed. Subsequently, the opening degree of the control valve 30 is adjusted, whereby the ore slurry is transferred to the shaking table 2. It should be noted that, also after the ore slurry starts to be transferred, the ore slurry may continue to be supplied into the ore supply tank 20, and may be intermittently supplied thereinto.

(Step 1: Opening Degree=Large)

In step 1, the gate valve 23 is opened, and the opening degree of the control valve 30 is made large (for example, 50%) and maintained for a shorter time (for example, 5 seconds) than in later-mentioned step 3. The opening degree of the control valve 30 of 0% (the state in step 0) causes the flow rate of an ore slurry of zero, and therefore, at first the opening degree is made large in order for the ore slurry to start to flow, or because, when the opening is insufficient, a blockage is caused even if the ore slurry starts to flow. Such operation makes it possible for the ore slurry to surely start to flow and to form a flow of the ore slurry without a blockage. During this operation, the flow rate of the ore slurry is considerably large.

(Step 2: Opening Degree=Medium)

In step 2, the opening degree of the control valve 30 is made medium (for example, 15%) and maintained for a shorter time (for example, 5 seconds) than in later-mentioned step 3. The opening degree of the control valve 30 in step 2 is larger than the opening degree thereof in later-mentioned step 3 (for example, 1.5 times as large as the opening degree thereof in step 3), and considerably smaller than the opening degree thereof in step 1. With such operation, the flow state which is formed in step 1 and in which the ore slurry surely starts to flow and a blockage is not caused can be maintained, meanwhile the flow rate of the slurry can be reduced. The reason for this is that, if the opening degree of the control valve 30 is reduced to the opening degree thereof in step 3 at once, sometimes a blockage in the piping unit 22 is easily caused although the flow rate of the ore slurry may be reduced more.

(Step 3: Opening Degree=Small)

In step 3, the opening degree of the control valve 30 is made the smallest (for example, 10%) among those in the three steps, and this opening degree is maintained for the time required for achieving the necessary amount of the ore supplied into the buffer container 60 through steps 1 to 3 (for example, 120 seconds). With such operation, the flow rate of the ore slurry is controlled to be sufficiently reduced, meanwhile the ore slurry flow can be maintained so as not to cause a blockage. The opening degree of the control valve 30 in step 3 is adjusted in such a way that the flow rate of the ore slurry is made slightly smaller than the amount of the ore slurry required for being supplied into the shaking table 2 by the ore supply launder 4 per unit time, and, the amount of an ore slurry supplied to the ore supply launder 4 in one cycle of the ore supply composed of steps 1 to 3 is made almost equal to the amount of an ore slurry treated by the table gravity concentrator 1 during one cycle of the ore supply (for example, 130 seconds).

Usually, in the storage unit 21, there is stored an ore slurry having an amount more than 10 times as much as an amount of an ore slurry transferred in one cycle of ore supply, and therefore, in the case of continuous operation, the ore supply cycle is repeatedly operated.

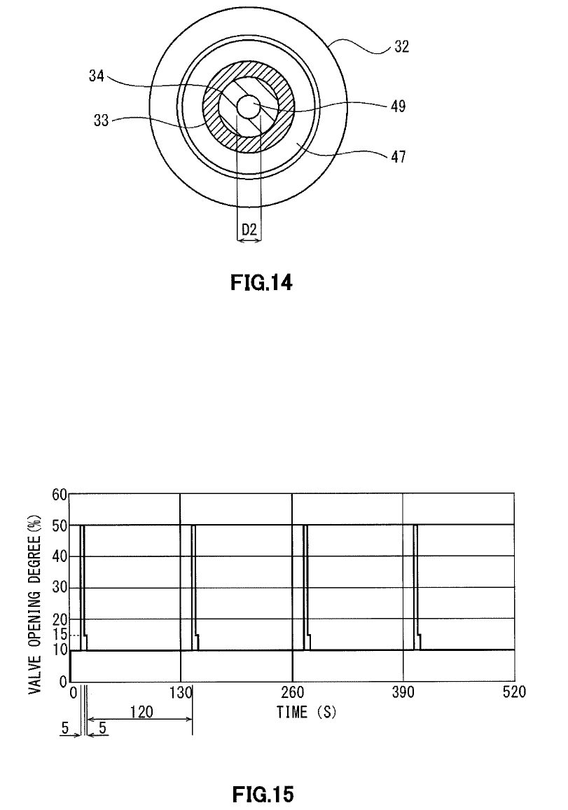

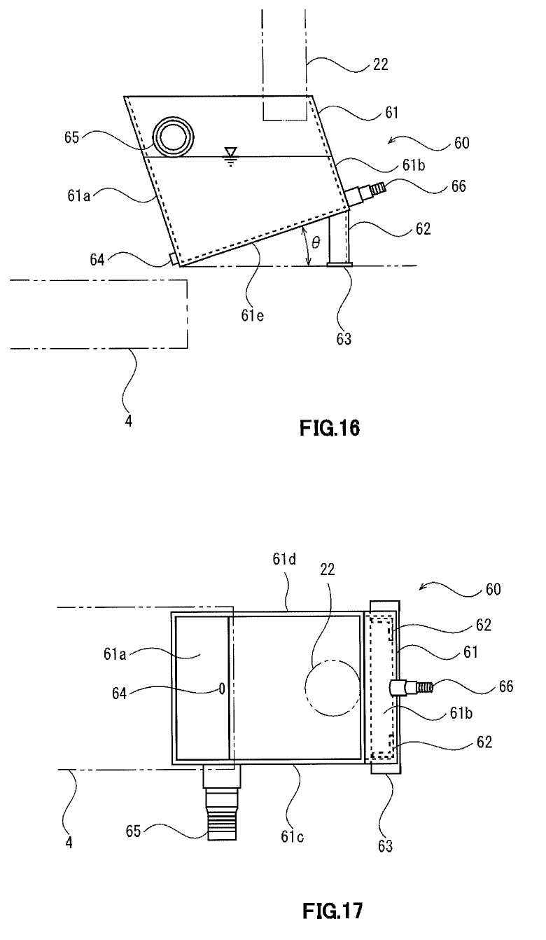

FIG. 16 is a side view illustrating a structure of the buffer container 60, and FIG. 17 is a plan view illustrating the structure of the buffer container 60. The buffer container 60 comprises: a storage unit 61 in the shape of a box having an open upper end portion; two legs 62 provided in a bottom surface 61e of the storage unit 61 and made of angle steel; and a plate 63 configured to connect the lower ends of the two legs 62. The storage unit 61 may have an arbitrary shape as long as the storage unit 61 can have a predetermined capacity, but, preferably has a rectangular parallelepiped shape. An ore supply nozzle 64 (an example of the outlet) configured to supply an ore slurry into the ore supply launder 4 is provided at the center of a lower end portion of a side surface 61a of the storage unit 61, the side surface 61a being shown on the left-hand side of FIG. 16 illustrating. A water supply nozzle 66 configured to supply water for washing the storage unit 61 is provided in a side surface 61b facing the side face 61a. In a side surface 61c shown on the lower side of FIG. 17, there is provided an overflow nozzle 65 configured to discharge an excessive ore slurry when an ore slurry is excessively supplied from the piping unit 22 of the ore supply tank 20. Nothing is provided in a side surface 61d facing the side face 61c.

The buffer container 60 is disposed to be inclined in such a manner that the lower end of the side face 61a and a plate 63 are placed on a base or the like not illustrated, and a bottom surface 61e is arranged to form a predetermined angle θ with respect to a horizontal plane, thereby making the ore supply nozzle 64 face downward. The height of the side face 61a and the height of the side face 61b are adjusted so that the upper end of the storage unit 61 is kept horizontal when the buffer container 60 is disposed to be inclined as mentioned above. Furthermore, the piping unit 22 is adjusted so as to be positioned apart from the ore supply nozzle 64 as far as possible and positioned in the vicinity of the side surface 61b.

The capacity of the storage unit 61 (a volume of an ore slurry stored at the time when the liquid level of said ore slurry coincides with the lower end of the overflow nozzle 65 as shown in FIG. 16.), the arrangement angle θ, and the diameter of the ore supply nozzle 64 are adjusted so that a desired amount of the ore slurry is supplied into the ore supply launder 4 per unit time. For example, in the case where an ore slurry produced from a gold ore was subject to the treatment, when the conditions that the capacity was 10 gallons (37.9 liters), the arrangement angle θ was 18 degrees, and the diameter of the ore supply nozzle 64 was 0.775 inches (19.7 mm) were set, an ore supply speed of 2.2 kg/min was achieved, hence, a preferable result was thus obtained.

A too large capacity of the storage unit 61 tends to easily cause a problem, such as sedimentation of solids inside the buffer container 60 or a blockage in the ore supply nozzle 64, and therefore, the capacity of the storage unit 61 is preferably not more than 1.5 times as much as an amount of an ore slurry supplied from the ore supply tank 20 in one ore-supply cycle comprising the above-mentioned steps 1 to 3.

As a material for the buffer container 60, steel, cast iron, synthetic resin, and the like may be used as long as they are capable of securing required strength and durability, but, it is preferable to use stainless steel as the material and to give a smooth finish to an inner surface of the buffer container 60.

It may be also beneficial that, without providing the legs 62 and the plate 63, a base or the like on which the buffer container 60 is placed is inclined, thereby making the bottom surface 61e to be inclined with respect to a horizontal plane.

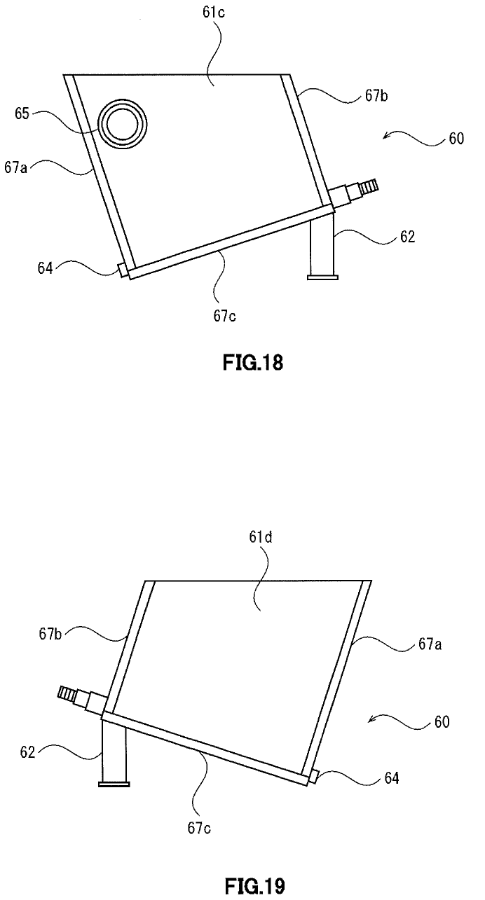

FIG. 18 is a front side view of the buffer container 60, and FIG. 19 is a back side view of the buffer container 60. The overflow nozzle 65 is provided on the upper portion of the side face 61c and in the vicinity of the side face 61a (refer to FIG. 17). Piping, not illustrated, for discharging an ore slurry is connected to the overflow nozzle 65. Each of a joint between the side surface 61a and the side surface 61c and a joint between the side surface 61a and the side surface 61d is reinforced using the angle steel 67a. Each of a joint between the side surface 61b (refer to FIG. 17) and the side surface 61c and a joint between the side surface 61b and the side surface 61d is reinforced using the angle steel 67b. Each of a joint between the bottom surface 61e (refer to FIG. 17) and the side surface 61c and a joint between the bottom surface 61e and the side surface 61d is reinforced using the angle steel 67c. The above-mentioned angle steels for reinforcement are not illustrated in FIG. 16 and FIG. 17.

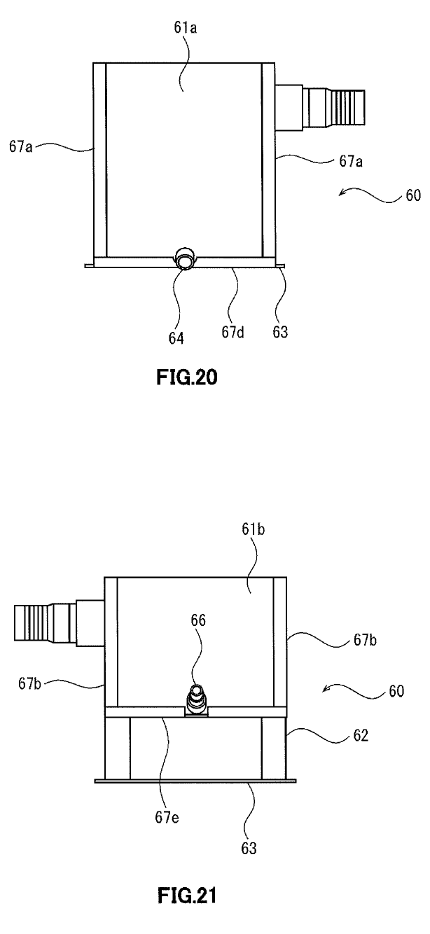

FIG. 20 is a left side view of the buffer container 60. The ore supply nozzle 64 is provided at the center of the lower end of the side face 61a in a right-and-left direction of FIG. 20. Without connecting a pipe or the like to the ore supply nozzle 64, an ore slurry is made to directly flow out to the ore supply launder 4 (refer to FIG. 16). A joint between the bottom surface 61e (refer to FIG. 17) and the side surface 61a is reinforced with the angle steel 67d. A notch is provided to a portion of the angle steel 67d wherein the ore supply nozzle 64 penetrates the angle steel 67d.

FIG. 21 is a right side view of the buffer container 60. The water supply nozzle 66 is provided at the center of the lower end of the side face 61b in a right-and-left direction of FIG. 21. A water supply hose, not illustrated, is connected to the water supply nozzle 66. A joint between the bottom surface 61e (refer to FIG. 17) and the side surface 61b is reinforced with the angle steel 67e. A notch is provided to a portion of the angle steel 67e wherein the water supply nozzle 66 penetrates the angle steel 67e.

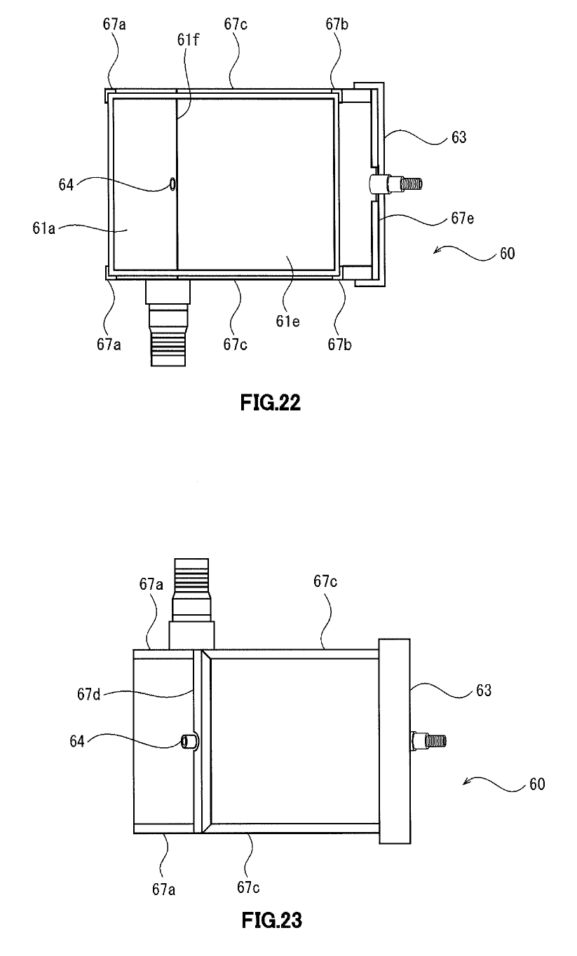

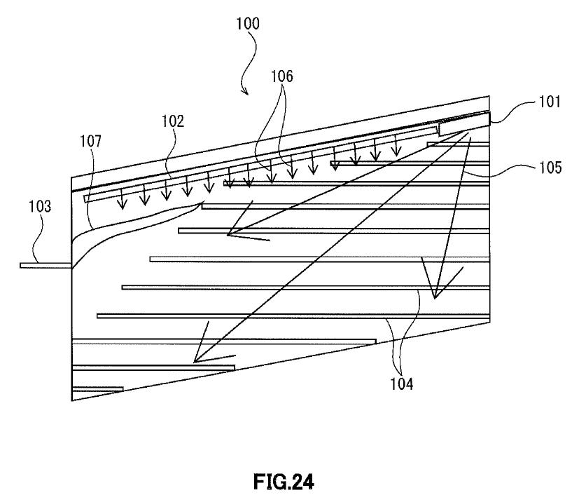

FIG. 22 is a plan view of the buffer container 60, and FIG. 23 is a bottom view of the buffer container 60. The ore supply nozzle 64 is arranged in the vicinity of a joint 61f between the side surface 61a and the bottom surface 61e, in other words, in the vicinity of the lowest position of the buffer container 60 when the buffer container 60 is disposed to be inclined as shown in FIG. 16. Each of the joints between the side surfaces 61a, 61b, 61c, and 61d and the joints between each of the side surfaces 61a, 61b, 61c, and 61d, and the bottom surface 61e is reinforced with a corresponding one of the angle steels 67a, 67b, 67c, 67d, and 67e.

As illustrated in FIG. 12, the control valve 30 has a configuration to adjust the opening degree thereof by changing the shape of the sleeve 34. When the opening degree of the control valve 30 is reduced, the shape of a cross-section along the central line of the ore slurry flow is an arc curve with respect to the ore slurry flow. In other words, the cross-sectional area of the flow path of an ore slurry gradually decreases toward the central portion of the control valve 30 from the end portion thereof. Thus, compared to butterfly valves, gate valves, and the like, the control valve 30 has a configuration by which a blockage less easily occurs even when the cross-sectional area of the flow path is small, because, in the control valve 30, an action in which piping is clogged up with an ore slurry (an action in which solids contained in an ore slurry form an arch) is distributed.

Furthermore, according to the present invention, the sealing pipe 24 which closely fits the cross-section of a remaining flow path at the time when the opening degree of the control valve 30 is adjusted to a minimum and has appropriate flexibility is arranged so as to be freely movable in a horizontal direction (the up-and-down, left-and-right direction in FIG. 11). Thus, even if a minute arch starts to be formed, a mass of ore slurry locally formed can flow with pushing the outer wall surface of the sealing pipe 24, and therefore, a blockage is not easily caused.

In the ore supply tank 20, the control valve 30 has a configuration in which the cross-sectional area of a flow path of an ore slurry is changed using the sleeve 34 made of elastomer and functioning as a valve body, and therefore a blockage in the piping unit 22 is not easily caused. Furthermore, the sealing pipe 24 or the sealing top 27 can completely seal the flow path of the ore slurry when the control valve 30 is adjusted so that the cross-sectional area of the flow path thereof is reduced to a minimum. Therefore, the ore supply tank 20 allows the flow rate of the ore slurry supplied from the piping unit 22 to be freely adjusted, whereby a stable ore-supply-amount can be secured. Furthermore, the ore slurry discharged from the piping unit 22 is accommodated in the buffer container 60 once, and then the ore slurry is supplied into the ore supply launder 4 from the ore supply nozzle 64 provided in the buffer container 60, and therefore, even if the flow rate of the ore slurry supplied from the piping unit 22 varies, the variation is absorbed, whereby the ore slurry can be supplied at a constant flow rate.

In the case where the sealing pipe 24 or the sealing top 27 is made of a soft material, said sealing pipe 24 or said sealing top 27 can change the shape itself when pressed by the sleeve 34, and therefore, some degree of deformation, for example, in the case of a circular section, the deviation from a perfect circle, is absorbed whereby the flow path can be surely sealed when the opening degree of the control valve 30 is adjusted to a minimum. Particularly, a sealing device having a circular tube shape like the sealing pipe 24 is preferable because such sealing device can easily change the shape itself as mentioned above. Furthermore, even if there is some unevenness in the outer surface of such sealing pipe 24 or such sealing top 27, the sleeve 34 can come into intimate contact with said sealing pipe 24 or said sealing top 27.

The sealing pipe 24 or the sealing top 27 is arranged so as to be horizontally movable. Therefore, an action in which an arch is formed by solids contained in an ore slurry is inhibited, whereby a blockage in the piping unit 22 is prevented from being easily caused. Furthermore, even if the central axis of the sealing pipe 24 or the sealing top 27 slightly deviates from the central axis of the piping unit 22, the sealing pipe 24 or the sealing top 27 can move horizontally when pressed by the sleeve 34, thereby completely sealing the flow path.

As shown in FIGS. 5, 6, and 8, the upper end of the sealing pipe 24 is arranged so as to be positioned above the upper end of the storage unit 21, and the sealing pipe 24 is rotatably supported by the storage unit 21 within a vertical plane, whereby, with a simple configuration, a horizontal movement of the sealing pipe 24 in the position of the control valve 30 can be achieved.

The bottom surface 61e of the buffer container 60 is arranged so as to form a predetermined angle with a horizontal plane, meanwhile the ore supply nozzle 64 is provided at the center of the lowest portion of the side surface 61a of the buffer container 60. Therefore, even when the amount of an ore slurry stored in the storage unit 61 is small, the ore slurry can be supplied into the ore supply launder 4 at a stable flow rate.

The control unit 51 controls the control valve 30 according to the ore supply cycle shown in FIG. 15. Thus, in step 1, an ore slurry can start to flow smoothly without causing a blockage. In step 2, the flow rate of the ore slurry can be reduced while a stable flow of the ore slurry is maintained. In step 3, the ore slurry flow can be maintained so as not to cause a blockage while the flow rate of the ore slurry is sufficiently reduced. The ore supply tank 20 enables an amount of the ore slurry required for the table gravity concentrator 1 to be stably supplied thereinto in proper amounts through the whole of such ore supply cycles. Furthermore, since the buffer container 60 is provided, the difference between the steps in the flow rate of the ore slurry supplied from the piping unit 22 can be absorbed.

When the buffer container 60 is made to have a capacity not more than 1.5 times as much as an amount of an ore slurry supplied in one cycle of the ore supply, sedimentation of solids and a blockage in the ore supply nozzle 64 can be prevented.

### REFERENCE SIGNS LIST

1 . . . table gravity concentrator, 2 . . . shaking table, 3 . . . weir, 4 . . . ore supply launder, 5 . . . water supply launder, 20 . . . ore supply tank (ore supply apparatus), 21 . . . storage unit, 22 . . . piping unit, 24 . . . sealing pipe (sealing device), 27 . . . sealing top (sealing device), 30 . . . control valve, 34 . . . sleeve (valve body), 50 . . . actuator, 51 . . . control unit, 60 . . . buffer container, 61 . . . storage unit, 64 . . . ore supply nozzle (outlet)

What is claimed is:

1. An ore supply apparatus comprises:
a storage unit configured to store an ore slurry;
a piping unit configured to discharge the ore slurry from the storage unit;
a control valve provided to the piping unit and configured to change a cross-sectional area of a flow path of the piping unit; and
a buffer container provided with an outlet and configured to once accommodate the ore slurry discharged from the piping unit and to supply the ore slurry into a concentrator from the outlet at a predetermined flow rate.

2. The ore supply apparatus according to claim 1, wherein
a bottom surface of the buffer container is arranged in such a way as to form a predetermined angle with a horizontal plane, and
the outlet is provided at a center of a lowest portion of a side surface of the buffer container.

3. The ore supply apparatus according to claim 1, comprising
a control unit configured to control an opening degree of the control valve,
wherein the control unit performs one or a plurality of ore supply cycle to supply the ore slurry, the ore supply cycle including:
a first step wherein an opening degree of the control valve is made large during a first time period;
a second step wherein an opening degree of the control valve is made medium during a second time period equivalent to the first time period; and
a third step wherein an opening degree of the control valve is made minimum during a third time period longer than the first time period and the second time period.

4. The ore supply apparatus according to claim 3, wherein
the buffer container has a capacity not more than 1.5 times as much as an amount of an ore slurry supplied in one cycle of the ore supply cycle.

5. The ore supply apparatus according to claim 1, wherein
stainless steel is used as a material for the buffer container, and
the buffer container has a smooth inner surface.

6. An ore supply method, comprising: supplying an ore slurry into a concentrator via a piping unit from a storage unit configured to store the ore slurry, wherein
the piping unit is provided with a control valve configured to change a cross-sectional area of a flow path of the piping unit; and
the ore slurry discharged from the piping unit is accommodated in a buffer container once, and supplied into a concentrator from an outlet provided to said buffer container.
